(19) United States
(12) Patent Application Publication
(10) Pub. No.: US 2026/0357094 A1
(43) Pub. Date: Nov. 12, 2026

(54) OXYGENATED GRAPHENE AEROSOL INKS WITH TUNABLE OXYGEN TO CARBON RATIO AND APPLICATIONS THEREOF

(71) Applicant: Kansas State University Research Foundation, Manhattan, KS (US)

(72) Inventors: Suprem R. Das, Manhattan, KS (US); Thiba Nagaraja, Manhattan, KS (US); Kh M. Asif Raihan, Manhattan, KS (US)

(21) Appl. No.: 19/129,841

(22) PCT Filed: Nov. 15, 2023
(86) PCT No.: PCT/US2023/079892

§ 371 Date: May 14, 2025

Related U.S. Application Data
(60) Provisional application No. 63/383,791, filed on Nov. 15, 2022.

(51) Int. Cl. C09D 11/322; C09D 11/36

(52) U.S. Cl. CPC C09D 11/322; C09D 11/36

(57) ABSTRACT

It has been discovered that the presence of oxygen in the graphene lattice of oxygenated graphene inks can provide a number of unique functionalities in various applications, particularly in energy storage. More specifically, it has been discovered that the oxygen to carbon ratio of the oxygenated graphene inks described herein contributes significantly to the superior performance of the various devices formed from the inks. Thus, these oxygenated graphene inks having a tunable O/C ratio may find utility in a number of downstream applications.

### RELATED APPLICATIONS

This application claims the priority benefit of U.S. Provisional Patent Application Ser. No. 63/383,791, entitled “GRAPHENE OXIDE NANO-INKS WITH TUNABLE OXYGEN TO CARBON RATIO AND PRINTED MICRO-ELECTRONIC DEVICES,” filed Nov. 15, 2022, the entire disclosure of which is incorporated herein by reference.

### STATEMENT REGARDING FEDERALLY SPONSORED RESEARCH AND DEVELOPMENT

This invention was made with government support under Award No. 1935676 awarded by the National Science Foundation. The government has certain rights in the invention.

### BACKGROUND

### 1. Field of the Invention

The present disclosure is generally related to oxygenated graphene aerosol inks and applications thereof. More particularly, the present disclosure is generally related to oxygenated graphene aerosol inks having a tunable oxygen to carbon ratio, which can be used to produce micro-electronics.

### 2. Description of the Related Art

Embedding power sources to electronics is an ever-growing concern in microelectronics, as the power source units do not scale proportionately like complementary metal oxide semiconductor (CMOS) chips. Moreover, high performance computing advances demand new classes of hybrid and sustainable power sources that are yet to be developed.

Supercapacitors are devices known for their high-performance deliverance. Furthermore, there is a need for a printed supercapacitor in all-solid-state form that can be produced on ubiquitous substrates, including flexible and bendable platforms. The development of such supercapacitors would have a great impact on a variety of electronics, including wearable electronics, wireless sensors, implantable medical devices, micro robots, and micro electro mechanical systems (MEMS). Moreover, co-designing scale down computing and power devices could further be exploited in complex IoT devices, including live monitoring of signal and feedback control.

The ever-growing demands in portable, bendable, twistable, and wearable microelectronics operating in a wide temperature range have stimulated immense interest for development of solid-state flexible energy storage devices using scalable fabrication technology. Consequently, there is a great demand for lightweight flexible microbatteries and microsupercapacitors (“MSCs”) as micropower (μ-power) units for powering smart electronic devices. MSCs have been demonstrated as favorable micropower sources with fast charge-discharge rates, high power density, and ultralong cycle life. Generally, most improvements in the electrochemical performance of MSCs have concentrated on proper selection of electrode materials with high surface area to enhance the specific energy (both volumetric and areal) and long cycle life combined with outstanding flexibility. Therefore, great effort has been given for development of electroactive material for fabrication of MSCs.

Amidst all electroactive material, graphene has become a highly encouraging contender for high-performance and flexible MSCs due to its large surface area, high theoretical capacitance, exceptional intrinsic electrical, and mechanical properties. Numerous techniques have been established to fabricate MSCs based on graphene electrodes. In 2014, Wu et al. developed a photolithography technique to fabricate all-solid-state, planar interdigital graphene-based MSCs. Later, this photolithography technique was commonly used for fabrication of interdigitated patterns of MSCs. But photolithography technique suffers from its high cost and indispensable sacrificial templates for fabrication of MSCs. Similarly, laser scribing and reduction technologies have also been used to fabricate micro-sized graphene electrodes with high-resolution patterns. However, the laser scribing technique can only work for limited electroactive materials.

Various promising additive manufacturing techniques with high resolution capabilities, such as inkjet printing, gravure printing, and aerosol jet printing, using graphene have shown promise due to rapid emphasis on development of large-scale graphene synthesis through low-cost liquid-phase processing. Printing supercapacitor devices provides a promising route for large scale manufacturing of energy storage devices. Screen-printing has been widely used for scalable fabrication of MSCs; however, the process requires mesh screens as a mask limits the customizability of the MSC design as well as the printing resolution. Therefore, to fabricate all-solid-state MSCs using nanoscale materials (such as graphene) in a scalable and sustainable manner at low cost and high resolution with customizable design, inkjet printing technology has been widely utilized. Even though research based on inkjet-printed graphene is in the early stages, it is predicted to have substantial effects on the market of wearable and portable electronic appliances. Only a few research studies have been reported based on fabrication of all-solid-state MSCs using inkjet printing technology with graphene as the electroactive material. For example, Li et al. demonstrated the scalable fabrication of graphene based MSCs on silicon wafer and polyimide films with good electrochemical performance.

Accordingly, further research and development is needed in order to provide a superior graphene-based ink that may be produced on a large scale and used to form high performance micro-electronics (e.g., MSCs).

### SUMMARY

One or more embodiments of the present disclosure generally relate to an oxygenated graphene aerosol ink comprising a plurality of graphene particles, wherein the graphene particles have an oxygen to carbon (“O/C”) ratio of at least 0.3.

One or more embodiments of the present disclosure generally relate to a method of forming an oxygenated graphene aerosol ink comprising a plurality of graphene particles, wherein the graphene particles have an O/C ratio of at least 0.3. Generally, the method comprises: (a) providing an initial detonation graphene powder having a O/C ratio of at least 0.3; (b) combining the initial detonation graphene powder with a first solvent and a binder under agitation to thereby form a graphene dispersion; (c) flocculating the graphene dispersion to thereby form a composite powder; and (d) forming the oxygenated graphene aerosol ink with the composite powder.

One or more embodiments of the present disclosure generally relate to an electronic device comprising a component formed from an oxygenated graphene aerosol ink. Generally, the oxygenated graphene aerosol ink comprises a plurality of graphene particles, wherein the graphene particles have an O/C ratio of at least 0.3.

One or more embodiments of the present disclosure generally relate to a process for forming an electronic device comprising a component formed from an oxygenated graphene aerosol ink. Generally, the process comprises printing the oxygenated graphene aerosol ink onto a substrate to thereby form a printed structure.

### BRIEF DESCRIPTION OF THE FIGURES

Embodiments of the present invention are described herein with reference to the following drawing figures, wherein:

FIG. 1 depicts a digital image of an exemplary microsupercapacitor according to one embodiment of the present disclosure;

FIG. 2 depicts a digital image of an exemplary microsupercapacitor according to one embodiment of the present disclosure;

FIG. 3 depicts a digital image of an exemplary microsupercapacitor according to one embodiment of the present disclosure;

FIG. 4 depicts a digital image of an exemplary array of supercapacitors in series and parallel configurations according to one embodiment of the present disclosure;

FIG. 5 depicts an exemplary microsupercapacitor according to Example 3;

FIG. 6 depicts a digital image of a device with microsupercapacitors in series according to Example 4; and

FIG. 7 depicts a digital image of a device with microsupercapacitors in parallel according to Example 4.

### DETAILED DESCRIPTION

It has been discovered that the presence of oxygen in the graphene lattice of oxygenated graphene aerosol inks can provide a number of unique functionalities in resulting applications utilizing such inks, such as (bio) sensing and energy storage. It has been observed that the oxygen to carbon ratio of the oxygenated graphene aerosol inks described herein contributes significantly to the high performance of the various devices formed from the inks. This addresses a need in the present market, as there is presently no oxygenated graphene aerosol nano-ink having a tunable O/C ratio that is currently available. Thus, the present disclosure is directed to the scalable production of oxygenated graphene aerosol nano-inks with a tunable oxygen to carbon ratio.

As discussed below, embodiments of the present disclosure are directed to formulation of oxygenated graphene aerosol nano-inks of various (O/C) ratios, and uses of those inks in creating various types of devices including printed electronics, flexible electronics, printed biosensors, and printed energy storage devices.

As discussed below, the oxygenated graphene aerosol gel inks described herein may be used to produce various electronics, such as flexible all-solid-state microsupercapacitors (“MSCs”) that may efficiently operate from −15 °C to 70 °C with highly stable and reliable energy storage performance.

### The Oxygenated Graphene Aerosol Gel Inks

As used herein, the term “oxygenated graphene aerosol ink” may be used interchangeably with the terms “oxygenated graphene ink,” “graphene oxide aerosol gel ink,” and “graphene oxide ink.” All of these terms refer to an oxygenated graphene aerosol ink having a tunable O/C ratio. The oxygenated graphene aerosol inks may be produced using a one-step industrially-scalable detonation process, as described below. More particularly, as described below, the process for producing the oxygenated graphene aerosol inks may first involve an initial explosion/detonation step to thereby form an oxygenated graphene aerosol powder (also referred to as an “aerosol gel powder”) that may have an O/C ratio of about 0.3, about 0.4, about 0.5, or about 0.75. Afterwards, this oxygenated graphene aerosol powder may be used as the starting material in forming the oxygenated graphene aerosol inks.

Generally, the first step in producing the oxygenated graphene aerosol inks involves forming the oxygenated graphene aerosol powder (“detonation graphene powder”) via an explosion/detonation step. During this step, at least one suitable hydrocarbon (e.g., acetylene) is combusted with oxygen in an enclosed reactor (e.g., an enclosed aluminum tank). In one or more embodiments, the mixture within the reactor comprises at least 25, 30, 35, 40, 45, 50, 55, 60, 65, or 70 and/or less than 95, 90, 85, 80, or 75 percent by volume of the hydrocarbon, based on the total volume within the reactor. Additionally, or in the alternative, the mixture within the reactor comprises at least 1, 5, 10, 15, 20, or 25 and/or less than 60, 50, 45, 40, 35, or 30 percent by volume of oxygen, based on the total volume within the reactor. In certain embodiments, the reaction mixture in the reactor comprises about 70 volume percent of hydrocarbon and about 30 volume percent of oxygen.

In one or more embodiments, the oxygenated graphene aerosol powder from the explosion/detonation step can have an oxygen to carbon (“O/C”) ratio of at least 0.1, 0.2, 0.3, 0.4, 0.5, 0.6, or 0.7 and/or less than 1.1, 1.0, 0.9, or 0.8. Additionally, or in the alternative, the O/C ratio can be from about 0.1 to about 1, from about 0.2 to about 0.9, or from about 0.3 to about 0.75. In certain embodiments, the oxygenated graphene aerosol powder from the explosion/detonation step can have an O/C ratio of about 0.3, about 0.4, about 0.5, or about 0.75. The O/C ratio may be based on the mass of elemental carbon and elemental oxygen within the ink.

Subsequently, the oxygenated graphene aerosol powder may be subjected to solvent-based exfoliation in order to prepare the oxygenated graphene aerosol ink. Generally, in one or more embodiments, the solvent-based exfoliation can involve the following steps:
1. Exfoliating and suspending the graphene flakes within the oxygenated graphene powder in a solvent to thereby form a reaction dispersion;
2. Optionally removing larger flakes from the reaction dispersion;
3. Flocculating the reaction dispersion; and
4. Removing the excess binder and/or surfactant from the reaction dispersion to thereby provide a composite oxygenated graphene aerosol powder.

Each of the above-referenced steps in the solvent-based exfoliation process are described below in greater detail.

During the exfoliating step, a set amount of at least one alcohol (e.g., ethanol) may be added to a container and combined with at least a portion of the oxygenated graphene aerosol powder under gentle agitation. Generally, in one or more embodiments, the alcohol is combined with the oxygenated graphene aerosol powder at a mL to mg ratio of 0.01, 0.05, 0.1, 0.2, 0.3, 0.4, or 0.5 and/or less than 2, 1.5, 1, 0.9, 0.8, or 0.7. Afterwards, at least one surfactant and/or binder (e.g., ethyl cellulose) may be added to the mixture at a surfactant to oxygenated graphene aerosol powder mass (g/g) ratio of at least 0.1, 0.2, or 0.3 and/or less than 1, 0.9, 0.8, 0.7, 0.6, or 0.5. Subsequently, the reaction mixture may be subjected to agitation for 1 to 24 or 3 to 12 hours at a temperature of 0 to 40 °C, 0 to 25 °C, or 0 to 10 °C in order to disperse the powder and surfactant within the alcohol. In various embodiments, the agitation may be carried out via sonication and may be carried out in an ice bath. The sonication may be carried out using a sonicator operating on pulse mode (e.g., pulse for five seconds, no pulse for five seconds, and then repeat).

Next, during the optional removal step, larger flakes within the suspension may be removed via filtration. Generally, in one or more embodiments, the filtration may be carried out with any known filter system known in the art, such as a filter syringe. In various embodiments, the filter may have a pore size of about 5 microns.

During the aforementioned flocculation step, an aqueous salt solution (e.g., a 0.04 g/mL sodium chloride solution) may be combined with the suspension at a suspension to salt solution volume ratio of 1:1 to 1:3 or about 1:2, and then subjected to agitation for 1 to 60 minutes or about 5 minutes. The agitation can be carried out using a magnetic stirrer or any other stirring device known in the art.

After flocculation, at least a portion of the excess surfactant may be removed from the flocculated suspension. This removal step can occur via filtration using any known filtration system in the art, such as a vacuum filter. After filtration, at least a portion of the filtered mixture may be washed repeatedly (e.g., five or six times) with distilled water to effectively remove any residual salts (e.g., sodium chloride). Subsequently, after filtration, at least a portion of the remaining mixture may be dried for 1 to 24 hours or 4 to 12 hours at a temperature in the range of 20 to 70 °C, 30 to 60 °C, or about 50 °C to thereby provide the composite oxygenated graphene aerosol powder.

The resulting composite oxygenated graphene aerosol powder from the exfoliation process may be used to form the oxygenated graphene aerosol ink. Generally, in one or more embodiments, the oxygenated graphene aerosol ink may be formed from the composite oxygenated graphene aerosol powder by combining the powder with one or more organic solvents and subjecting this mixture to agitation to thereby form a homogeneous ink. In various embodiments, the organic solvents can be a solvent mixture comprising at least two different solvents. In such embodiments, the solvents can be a hydrocarbon (e.g., cyclohexane) and/or an alcohol (e.g., terpinol). In certain embodiments, a solvent mixture is utilized that contains cyclohexane and terpinol at a volume to volume ratio of about 85:15.

In one or more embodiments, the composite oxygenated graphene aerosol powder and the solvent may be combined at a gram to liter ratio of at least about 0.01, 0.05, or 0.1 and/or less than 1, 0.7, 0.5, 0.4, 0.3, or 0.2.

The agitation during ink preparation may occur over a time period of 1 to 240 minutes, 1 to 90 minutes, or 10 to 60 minutes at a temperature of 10 to 50 °C, 15 to 40 °C, or about 23 °C. In such embodiments, the agitation may comprise sonication.

Due to the detonation process and the control of oxygen into the detonation process, the resulting oxygenated graphene aerosol ink may comprise a plurality of graphene particles having a tunable O/C ratio. In one or more embodiments, the oxygenated graphene aerosol ink may comprise at least 1, 5, 10, 15, 20, or 25 weight percent and/or less than 90, 80, 70, 60, 55, 50, or 45 weight percent of the graphene particles. In various embodiments, the oxygenated graphene aerosol ink may comprise 10 to 60, 15 to 55, or 20 to 50 weight percent of the graphene particles.

In one or more embodiments, the oxygenated graphene aerosol ink may comprise at least 1, 5, 10, 15, 20, 25, 30, or 35 weight percent and/or less than 90, 85, 80, 75, 70, 65, or 60 weight percent of the aforementioned solvents.

In one or more embodiments, the graphene particles within the oxygenated graphene aerosol ink can have an O/C ratio that is at least 0.1, 0.2, 0.3, 0.4, 0.5, 0.6, or 0.7 and/or less than 1.1, 1.0, 0.9, or 0.8. Additionally, or in the alternative, the O/C ratio can be from about 0.1 to about 1, from about 0.2 to about 0.9, or from about 0.3 to about 0.75. As noted above, the O/C ratio may be based on the mass of elemental carbon and elemental oxygen within the graphene particles (as measured after application of the ink) and/or the ink.

In one or more embodiments, the graphene particles within the oxygenated graphene aerosol ink can have an O/C ratio that is at least 0.3, at least 0.4, at least 0.5, or at least 0.75. Additionally, or in the alternative, the O/C ratio is from about 0.1 to about 1, from about 0.2 to about 0.9, or from about 0.3 to about 0.75.

In one or more embodiments, the graphene particles within the oxygenated graphene aerosol ink can comprise at least 40, 45, 50, 55, 60, 65, or 70 weight percent of elemental carbon as determined by Energy Dispersive X-ray Spectroscopy (“EDS”). Additionally, or in the alternative, the graphene particles within the oxygenated graphene aerosol ink can comprise less than 99, 95, 90, 85, 80, 75, 70, 65, or 60 weight percent of elemental carbon as determined by EDS.

In one or more embodiments, the graphene particles within the oxygenated graphene aerosol ink can comprise at least 1, 5, 10, 15, 20, 25, or 30 weight percent of elemental oxygen as determined by EDS. Additionally, or in the alternative, the graphene particles within the oxygenated graphene aerosol ink can comprise less than 60, 55, 50, 45, 40, 35, or 30 weight percent of elemental oxygen as determined by EDS.

In one or more embodiments, the graphene particles within the oxygenated graphene aerosol ink can have a maximum transverse dimension of at least 1, 5, 10, 15, 20, 25, 30, 35, 40, 45, or 50 nm. Additionally, or in the alternative, the graphene particles within the oxygenated graphene aerosol ink can have a maximum transverse dimension of less than 500, 400, 300, 250, 200, 175, 150, 125, 100, 90, 80, 70, 60, 50, 40, 30, 20, 15, 10, 9, 8, 7, or 6 nm. As used herein, the “maximum transverse dimension” refers to the largest dimension of the graphene particles.

In one or more embodiments, the graphene particles can have a platelet shape.

In one or more embodiments, the graphene particles can be multilayered. For example, the graphene particles may comprise at least 2, 3, 4, 5, 6, 7, or 8 layers of graphene sheets. Additionally, or in the alternative, the graphene particles comprise less than 15, 14, 13, 12, 11, 10, 9, 8, 7, or 6 layers of graphene sheets.

The oxygenated graphene aerosol ink may also contain some impurities derived from the solvent-based exfoliation process. In one or more embodiments, the graphene particles within the oxygenated graphene aerosol ink can comprise at least 0.001, 0.005, 0.01, 0.05, or 0.1 weight percent of elemental sodium and/or elemental chlorine as determined by EDS. Additionally, or in the alternative, the graphene particles within the oxygenated graphene aerosol ink can comprise less than 2, 1, 0.5, 0.4, 0.3, or 0.2 weight percent of elemental sodium and/or elemental chlorine as determined by EDS.

As described below in greater detail, several products can be produced from the oxygenated graphene aerosol inks described herein, including but not limited to, printed surfaces, biosensors, supercapacitors, battery electrodes, composites for battery and supercapacitors, and antibacterial and antiviral surfaces. These devices and methods of fabricating the same are described below.

### Printed Electronics and Micro-Supercapacitors (MSCs)

It has been observed that the oxygenated graphene aerosol inks described herein can be printed, particularly via ink jet printing, on selected substrates in order to form printed micro-electronics, such as a flexible all-solid-state microsupercapacitor (“MSC”).

In one or more embodiments, the oxygenated graphene aerosol ink may be printed onto a substrate. In such embodiments, the printing can be inkjet printing. In certain embodiments, the printing occurs in the absence of a current collector, a conductive additive, or a separator.

In one or more embodiments, the oxygenated graphene aerosol ink may be used to produce printed electronics, such as an MSC. In such embodiments, the oxygenated graphene aerosol ink may be inkjet printed as an electrode on a designated substrate (e.g., a polyimide film). Afterwards, a conductive ink (e.g., a silver ink) may be inkjet printed on the electrodes. Subsequently, a solid state electrolyte (e.g., PVA-H₃PO₄) may then be printed on top of the oxygenated graphene electrodes. In various embodiments, each of the printing steps may be followed by a thermal annealing step (e.g., heat treatment at 250 to 400 °C for 1 to 4 hours) in order to remove excess surfactants and/or binders from the inks. This can help increase the electrical and mechanical properties of the MSC.

The electrodes may comprise, consist essentially of, or consist of the oxygenated graphene inks. More particularly, in one or more embodiments, the electrodes may comprise, consist essentially of, or consist of the graphene particles derived from the oxygenated graphene inks described herein.

In one or more embodiments, the electrodes formed from the oxygenated graphene inks may comprise any number of desired fingers, such as at least 2, 3, 4, 5, 6, 7, or 8 fingers and/or less than 50, 40, 35, 30, 25, 20, 15, or 10 fingers.

In one or more embodiments, the electrodes formed from the oxygenated graphene inks may comprise a length of at least 0.1, 0.5, 1, 2, or 3 mm and/or less than 15, 10, 9, 8, 7, 6, or 5 mm.

In one or more embodiments, the electrodes formed from the oxygenated graphene inks may comprise a width of at least 0.01, 0.05, 0.1, 0.2, or 0.3 mm and/or less than 5, 4, 3, 2, or 1 mm.

In one or more embodiments, the electrodes formed from the oxygenated graphene inks may comprise a surface area of at least 1, 5, 10, 15, or 20 mm² and/or less than 100, 50, 40, or 30 mm².

In one or more embodiments, the electrodes formed from the oxygenated graphene inks may comprise a volume of at least 0.01, 0.02, or 0.04 mm³ and/or less than 1, 0.8, or 0.6 mm³.

In one or more embodiments, the electrodes formed from the oxygenated graphene inks may have a thickness of 0.1 to 20 μm, 0.5 to 10 μm, 0.5 to 5 μm, or 1 to 3 μm.

Flexible all-solid-state microsupercapacitors (MSCs) produced with the oxygenated graphene inks may efficiently operate from −15 °C to 70 °C with highly stable and reliable energy storage performance.

In one or more embodiments, an MSC fabricated with the oxygenated graphene ink may exhibit a volumetric specific capacitance of 300 to 450, 325 to 425, 350 to 390, or about 376 mF cm⁻³ at an applied current of 0.25 μA.

In one or more embodiments, an MSC fabricated with the oxygenated graphene ink may exhibit an areal specific capacitance in the range of 40 to 120, 50 to 100, 70 to 80, or about 76 μF cm⁻² at the applied current of 0.25 μA and/or a at a sweep rate of 5 mV s⁻¹.

In one or more embodiments, an MSC fabricated with the oxygenated graphene ink may exhibit a volumetric specific capacitance of 300 to 450, 325 to 425, or about 351 mF cm⁻³ at a low sweep rate of 5 mV s⁻¹.

It was also observed that the mechanical flexibility of MSCs formed with the oxygenated graphene inks exhibited negligible capacitance changes (after long cycles) at various bending states. In one or more embodiments, an MSC fabricated with the oxygenated graphene ink may exhibit a cyclic stability of at least 99, 99.5, or 99.6 percent at a constant applied current of 1 μA after 10,000 cycles.

In one or more embodiments, an MSC fabricated with the oxygenated graphene ink may exhibit a capacitance retention of at least 90, 91, 92, 93, 94, 95, 96, 97, 98, or 99 percent after 500 cycles at a bending radius of 4 mm, 7.5 mm, 10 mm, or 15 mm at a constant sweep rate of 100 mV s⁻¹ and a constant applied current of 1 μA.

Moreover, MSCs formed with the oxygenated graphene inks can exhibit superior temperature-dependent supercapacitive performance through a wide range of temperatures (-15 °C to 70 °C.).

In one or more embodiments, an MSC fabricated with the oxygenated graphene ink may exhibit a maximum specific capacitance of 200 to 450, 300 to 400, 325 to 375, or about 343 mF cm⁻³ at 70 °C and at a constant sweep rate of 100 mV s⁻¹ and/or at a constant applied current of 1 μA (based on CV profile).

In one or more embodiments, an MSC fabricated with the oxygenated graphene ink may exhibit a maximum specific capacitance of 200 to 450, 250 to 400, or 300 to 400 mF cm⁻³ at 30 °C, 40 °C, 50 °C, or 60 °C and at a constant sweep rate of 100 mV s⁻¹ and/or at a constant applied current of 1 μA (based on CV profile).

In one or more embodiments, an MSC fabricated with the oxygenated graphene ink may exhibit a minimum specific capacitance of 150 to 400, 200 to 350, 225 to 260, or about 240 mF cm⁻³ at −15 °C and at a constant sweep rate of 100 mV s⁻¹ and/or at a constant applied current of 1 μA (based on CV profile).

In one or more embodiments, an MSC fabricated with the oxygenated graphene ink may exhibit a maximum specific capacitance of 200 to 475, 300 to 450, 325 to 425, or about 400 mF cm⁻³ at 70 °C and at a constant sweep rate of 100 mV s⁻¹ and/or at a constant applied current of 1 μA (based on CD profile).

In one or more embodiments, an MSC fabricated with the oxygenated graphene ink may exhibit a maximum specific capacitance of 300 to 450, 325 to 425, or 350 to 415 mF cm⁻³ at 30 °C, 40 °C, 50 °C, or 60 °C and at a constant sweep rate of 100 mV s⁻¹ and/or at a constant applied current of 1 μA (based on CD profile).

In one or more embodiments, an MSC fabricated with the oxygenated graphene ink may exhibit a minimum specific capacitance of 150 to 400, 200 to 350, or 225 to 300 mF cm 3 at −15 °C and at a constant sweep rate of 100 mV s⁻¹ and/or at a constant applied current of 1 μA (based on CD profile).

In one or more embodiments, an MSC fabricated with the oxygenated graphene ink may exhibit an areal specific capacitance of 45 to 85, 50 to 80, or 60 to 75 mF cm⁻³ at 30 °C, 40 °C, 50 °C, 60 °C, or 70 °C and at a constant sweep rate of 100 mV s⁻¹ and/or at a constant applied current of 1 μA (based on CV profile).

In one or more embodiments, an MSC fabricated with the oxygenated graphene ink may exhibit an areal specific capacitance of 40 to 65, 45 to 60, or 45 to 55 mF cm⁻³ at −10 °C or −15 °C and at a constant sweep rate of 100 mV s⁻¹ and/or at a constant applied current of 1 μA (based on CV profile).

In one or more embodiments, an MSC fabricated with the oxygenated graphene ink may exhibit an areal specific capacitance of 45 to 85, 50 to 80, or 60 to 75 mF cm⁻³ at 30 °C, 40 °C, 50 °C, 60 °C, or 70 °C and at a constant sweep rate of 100 mV s⁻¹ and/or at a constant applied current of 1 μA (based on CD profile).

In one or more embodiments, an MSC fabricated with the oxygenated graphene ink may exhibit an areal specific capacitance of 40 to 65, 45 to 60, or 45 to 55 mF cm⁻³ at −10 °C or −15 °C and at a constant sweep rate of 100 mV s⁻¹ and/or at a constant applied current of 1 μA (based on CD profile).

The specific capacitance (Csp) (both volumetric and areal), energy density (E) and power density (P) of the graphene aerosol gel based solid-state MSC may be calculated using the following relations:

Cₛₚ−[(∫I dV)/2(s×ΔV×m)] (1)

Cₛₚ=[(I×Δt)/(ΔV×m)] (2)

E=(0.5×Cₛₚ×ΔV₂) (3)

P=E/Δt (4)

Here, “Cₛₚ” is the specific capacitance (F cm⁻³ and F cm⁻²), “I” is the current (A), “ΔV”′ is the potential window (V), “s” is the scan rate (mVs⁻¹), “Δf” is the discharge time(s), and “m” is the mass of the active material (g).

In one or more embodiments, MSCs with modular connections in series and parallel may also be produced with the oxygenated graphene inks described herein. Micro energy storage systems with customized voltage and current output by modular connections (series and/or parallel) are highly desired to meet real-time applications. The printing methods described herein are a very attractive technique to realize the development of such modular energy storage systems.

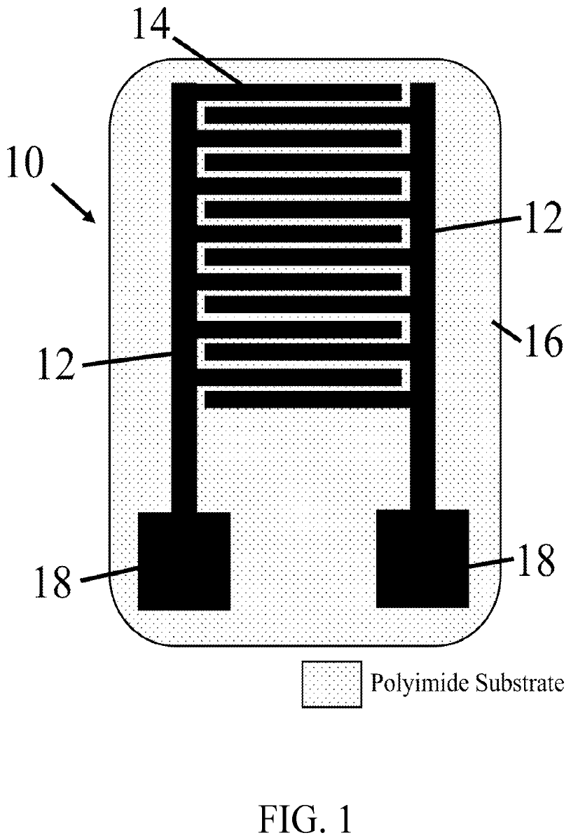

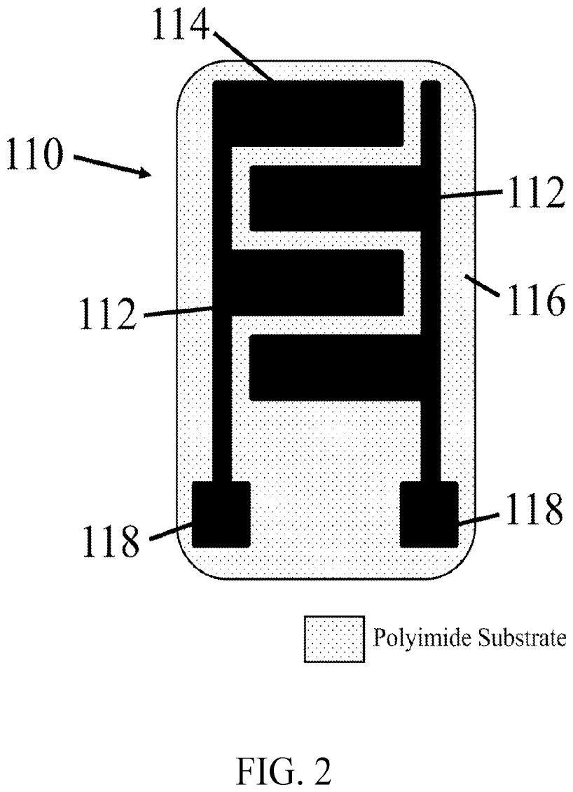

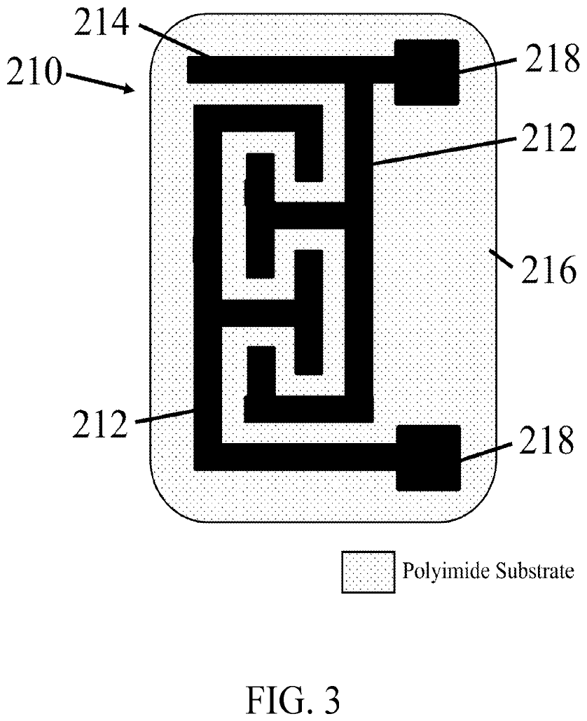

Due to the convenience of the inkjet printing method, various shapes and sized MSCs can be conceptualized and designed, as demonstrated in FIGS. 1-3. In FIG. 1, an exemplary MSC 10 is shown with two electrodes 12 comprising a plurality of fingers 14 printed on a polyimide film substrate 16. Each of the electrodes 12 has an electron contact point 18. Likewise, FIG. 2 also shows an MSC 110 containing two electrodes 112 printed in a film substrate 116 with each electrode having a contact point 118; however, each of the electrodes 112 in the MSC 110 of FIG. 2 contains thicker electrode fingers 114. Similarly, FIG. 3 depicts yet another embodiment of an MSC 210 that contains two electrodes 12 with a number of differently shaped fingers 214 printed on a polyimide substrate 216, with each electrode 212 containing individual contact points 218.

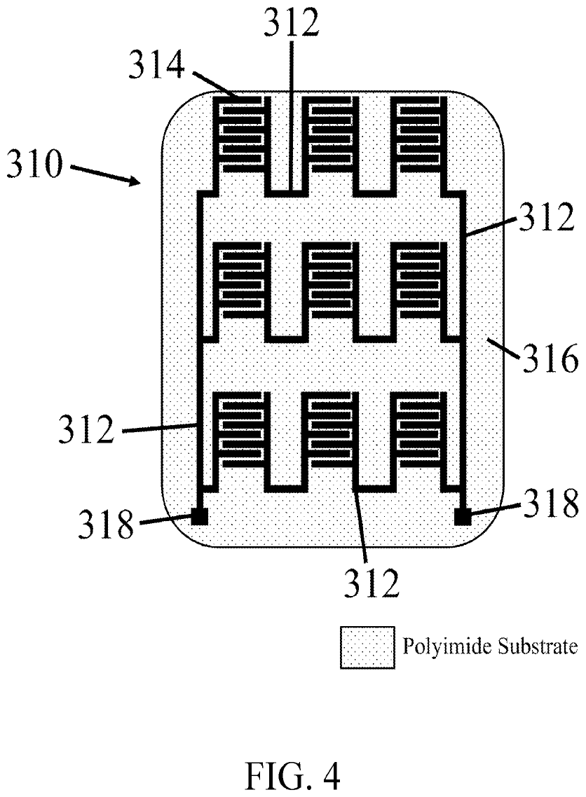

Additionally, as exemplified in FIG. 4, an array of supercapacitors 10 comprising of series and parallel designs can be produced. More particularly, as shown in FIG. 4, an MSC 310 may be produced that comprises multiple electrodes 312, with each electrode 312 having a plurality of electrode fingers 314, arranged in both series and parallel configurations. As with the other MSCs described herein, the MSC 310 may be printed on a film substrate 316 and contain two contact points 318. The outstanding design flexibilities of the energy storage systems, enabled by additive manufacturing, therefore, could be exploited to envision wide variety of applications such as shape conformable wearable devices and IoT electronics for sensors.

The electrochemical performance of MSCs formed with the oxygenated graphene inks demonstrate a promising way to develop highly scalable and reliable future miniaturized energy storage devices for applications such as integrated wearable electronics. More particularly, the inkjet-printed MSC is a promising candidate for wide temperature tolerant, bendable, and twistable energy storage systems for powering miniaturized electronics.

In summary, a wide-temperature tolerant all-solid-state and inkjet-printed MSC has been produced with the oxygenated graphene inks described herein. The method disclosed herein could further be adopted for a scalable manufacturing of MSCs with robust mechanical flexibility for a number of potential applications, such as wearable and IoT electronics. The fabricated MSCs may exhibit highly reliable electrochemical performances, such as desirable volumetric specific capacitances, excellent cyclic stability over 10,000 cycles, good integration ability, and robust mechanical flexibility. Consequently, the MSCs described herein provide numerous opportunities for the scalable design of miniaturized energy storage devices for the next generation of microelectronics and microelectromechanical systems used in miniaturized Internet of Thing technologies.

Accordingly, the electrochemical performance of the oxygenated graphene inks described herein offers a new avenue for facile, all-solid-state, and flexible energy storage devices for microelectronics applications.

This invention can be further illustrated by the following examples of embodiments thereof, although it will be understood that these examples are included merely for the purposes of illustration and are not intended to limit the scope of the invention unless otherwise specifically indicated.

### Examples

### Example 1—Production of Oxygenated Graphene Ink

Volumetric 70% acetylene and 30% oxygen were controllably detonated at a high temperature in a 17 L aluminum chamber. This high heat energy played a critical role in the formation of about 7.5 g of detonation graphene yielding 7.5 g. The detonation powder was then infused with ethyl cellulose, which acted as a binder to improve the solubility and flowability of the oxygenated graphene ink. Ethyl Cellulose was first dissolved in 50 mL of ethanol in a 2 mg/mL concentration through ultrasonic bath sonication. Subsequently, 250 mg of graphene detonation powder was added to the solution and was subjected to a high shear force using an ultrasonic probe sonicator (Qsonica 500, 20 KHz) to form a homogeneous dispersion. The dispersion was collected and filtered through 5 μm filter to get rid of any remaining large agglomeration. Then the filtered dispersion was flocculated with NaCl and filtered in a vacuum filtration system using a 47 mm diameter 0.45 μm cellulose filter (Sigma Aldrich). The filtrate powder was dried overnight on a hotplate at 50 °C and stored to make ink as required. Finally, the printable oxygenated graphene ink was formulated by uniformly suspending the oxygenated graphene powder in a binary solvent system (cyclohexanone:terpineol=85:15) with the help of ultrasonic bath sonication for 2 hours. The prepared ink was tested stable over several months while stored at 9 to 11 °C in a refrigerator.

### Example 2—Production of MSC from Oxygenated Graphene Inks

The oxygenated graphene ink from Example 1 was used to produce an MSC. A high precision Microplotter II from Sonoplot Inc. was used to print the interdigitated supercapacitor electrodes, which was equipped with a piezoelectric 40 μm glass nozzle. The in-built drawing software was used to create the graphics and to define the dimensions of the interdigitated electrodes. The electrodes were printed on a 25 μm polyimide film (Sigma Aldrich), which was thoroughly cleaned with acetone, methanol and an IPA solvent using an ultrasonic cleaner. Once the printing was finished, the printed electrodes were annealed at 350 °C on top of a hot plate for 2 hours to get rid of the organic non-conductive binder.

Subsequently, PVA-H₃PO₄ electrolyte was prepared by dissolving 1 g of polyvinyl alcohol in 10 mL of deionized water at a higher temperature under continuous and rigorous stirring. When the solution color became transparent and all the PVA was dissolved homogeneously in water, the solution was cooled down to room temperature. At room temperature, 0.8 g of concentrated H₃PO₄ (85 wt. % aqueous solution, Sigma Aldrich) was added to the solution and magnetically stirred for 12 hours to ensure a homogeneous mixture. The prepared electrolyte was stored in a vacuum chamber before printing the electrolyte. The electrolyte was heated at 60 °C for 10 minutes to ensure better contact at the interface so that no air could be entrapped.

Voltera V One PCB printer was used to print conductive ink (silver paste) on the electrode contact point. The square pattern was drawn via KiCad open resource software and after sample set up and alignment conductive ink was mounted on the robotic arm of the printer, which controlled the deposition of ink by mechanical gear mechanism. After printing the silver ink, the electrodes were heated at 200 °C for 10 minutes to get rid of any residual organic materials in the ink and to solidify the contact point.

The electrolyte was also printed using the Voltera V one printer. The prepared electrolyte was heated at 60 °C for 10 minutes to ensure better contact at the interface so that no air could be entrapped in between. Then the electrolyte was loaded into the ink holder and mounted on the robotic arm. An 8 mm×7 mm rectangular pattern was drawn and printed to ensure the electrolyte layer covered the whole device. After electrolyte printing, the device was air dried for 24 hours to complete the fabrication of the solid-state MSC.

The uniformity and surface morphology of the printed pattern were investigated using low- and high-resolution scanning electron microscope (SEM). Captured micrographs of the electrode fingers showed uniform printing features without any coffee ring effect. Measured dimensions were as per with the designed features made using the CAD software of the inkjet printer (Sonoplot Microplotter). The high-resolution SEM taken on the IDE fingers revealed an abundance of nanoscale shell-like structures, that can impart increasing porosity in the electrodes so that the electrolyte can have better interaction with the electrode material, which positively influenced the specific capacitance.

Further, high resolution transmission electron microscopy (TEM) was performed on the graphene aerosol gel ink material to further analyze the crystal structure and number of graphene layers. The TEM micrographs revealed a multi-layered, crumpled, and shell-like structure of the oxygenated graphene ink. To understand the average shell heights/thicknesses, atomic force microscopy (AFM) was used, and non-spheroid graphene shell-platelets in the range of 4.5-6.5 nm were observed. As these structures were not flat sheets of graphene, it was challenging to directly interpret the exact number of atomic layers from the AFM thickness measurements, although correlating the Raman and TEM analysis it can be proposed that there were 5 to 10 layers of graphene sheets forming the walls of the shell-like graphene particles within the oxygenated graphene ink.

The elemental distributions of the graphene particles from the oxygenated graphene ink material forming the electrode were measured using energy dispersive X-ray spectroscopy (EDS). The results of this analysis are provided in TABLE 1, below.

TABLE 1

| Element | Atomic Weight % |
|---|---|
| C | 71.643 |
| O | 28.171 |
| Na | 0.134 |
| Cl | 0.052 |
| Total | 100 |

EDS mapping on the bare electrode showed about 71% of the electrode material as pure carbon, while the rest of the atomic composition was predominantly identified as oxygen, which is in line with the original precursor composition during the synthesis of the graphene detonation powder. There were also trace amounts of sodium and chlorine, which were residual materials in the ink during the flocculation step in ink synthesis. However, it only constitutes ~0.2%, signifying a very low concentration in the oxygenated graphene ink.

### Example 3—Production of MSC from Oxygenated Graphene Inks

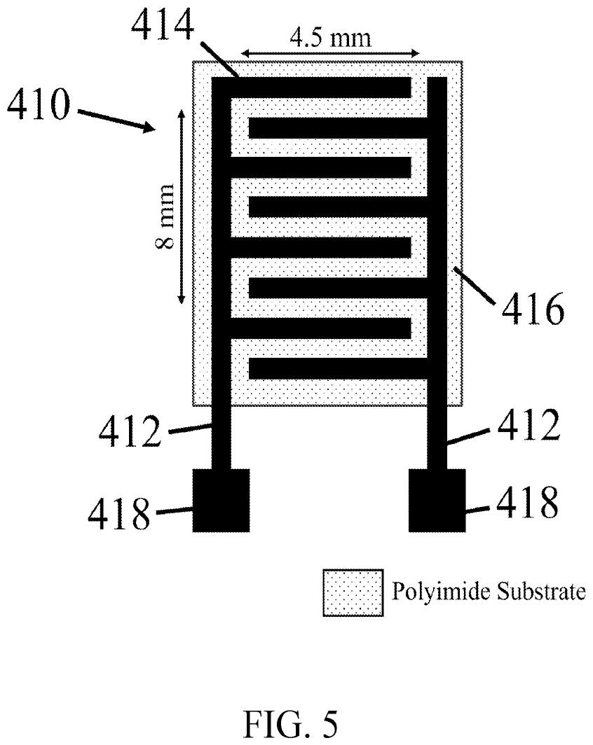

An MSC was produced with the oxygenated graphene ink from Example 1 using the printing method described in Example 2. The MSC had the two-electrode configuration as shown in FIG. 5. As shown in FIG. 5, the MSC 410 had two electrodes 412 with a plurality of electrode fingers 414 printed on a polyimide substrate 416. The MSC 410 also contained two contacts points 418. The general dimensions of the electrode formed with the oxygenated graphene ink are provided in TABLE 2, below.

TABLE 2

| Number of Electrode Fingers | N | 8 | |
|---|---|---|---|
| Length | L | 4.5 | mm |
| Width | W | 0.5 | mm |
| Finger Thickness | t | 0.002024 | mm |
| Side Electrode Length | SL | 8.00 | mm |
| Side Electrode Width | SW | 0.5 | mm |
| Contact Point | B | 1.5 | mm |
| Area | L*W*N + SL*SW*2 | 26 | mm² |
| Volume | Area * t | 0.052624 | mm³ |

It was confirmed via SEM cross-sectional micrograph that the electrode layer had a thickness of about 2 microns.

A series of electrochemical tests were carried out on this two-electrode configuration to evaluate the supercapacitive performance.

Cyclic voltammetry (CV) profiles of the MSC were recorded over 1.0 V with various applied sweep rates (from 5 to 500 mV s−1). The CV profiles of were rectangular in nature at a very low sweep rate (5 mV s−1) and held the nature even with in an increase in the sweep rate 100 mV s⁻¹ (20-fold), signifying a better capacitive behavior. Although the shape of the CV profiles changed from rectangular to quasi-rectangular nature with an increase in the sweep rates (>150 mV s−1), this can be explained due to the internal resistance and limited mass transport of electrolyte ions at the higher sweep rates. It was observed that the MSC exhibited a high volumetric specific capacitance of 351.05 mF cm⁻³ at a low sweep rate of 5 mV s⁻¹.

The MSC maintained about 42.20% of its initial volumetric specific capacitance, even when the sweep rate was increased 100-fold (500 mV s−1), suggesting better rate performance. Additionally, a galvanostatic charge-discharge (CD) profile of the MSC at various applied current (from 3 to 0.25 μA) indicated a symmetric triangular shape of the CD profile and based on the applied current, the behavior of charge-discharge profiles become rapid at high current ranges and vice versa.

Five continuous CD profiles of the MSC were recorded at a constant applied current of 1 μA and indicated a triangular shape of CD with good symmetry at the successive cycles. Interestingly, the MSC obtained a coulombic efficiency of about 98% at various charge discharge cycles. The MSC demonstrated the highest volumetric specific capacitance of 376.63 mF cm⁻³ at the lowest applied current of 0.25 μA. Additionally, the fabricated MSC obtained a highest areal specific capacitance of 71.05 μF cm⁻² at a sweep rate of 5 mV s⁻¹ (from CV profile) and 76.23 μF cm⁻² at an applied current of 0.25 μA (from CD profile). Furthermore, it was observed that the MSC exhibited a volumetric energy density value of 52.3 μWh cm⁻³ at the volumetric power density of 2.38 mW cm⁻³ and it was able to retain 34.8 μWh cm⁻³ when the MSC obtained higher power density of 28.5 mW cm⁻³.

In order to carry out the long-term cyclic stability of the MSC, a continuous CD test was performed at a constant applied current of 1 μA over 10,000 cycles. The MSC exhibited excellent capacitance retention (about 99.6%) over 10,000 cycles. The achieved capacitance retention (99.6%) over 10,000 cycles of the MSC is higher compared to the recently reported solid state MSCs formed from cellular graphene (97.6%), porous carbon (94%), LSG/SWCNTs (88.6%), graphene-carbon sphere (95%), reduced oxygenated graphene (94.6%), laser-scribed graphene (87%), and graphene (99%).

To establish the robust mechanical flexibility of the MSC, a series of electrochemical tests were carried out under various bending and twisting states. The comparative CV and CD profiles of the MSC at a constant sweep rate of 100 mV s⁻¹ and a constant applied current of 1 μA under various bending states (at radius of curvature of about 7.5 mm, 10 mm, 15 mm, and 4 mm) were carried out (over continuous 500 cycles). Remarkably, the CV and CD curves of the MSC were identical at various bending states. The MSC exhibited a capacitance retention of 100%, 97.24%, 83.33%, and 80.33% under a bending radius of 7.5 mm, 10 mm, 4 mm, and 15 mm, respectively. Moreover, the MSC was fully twisted, and an electrochemical test was carried out over 500 cycles. The twisted MSC exhibited a capacitance retention of about 86.20% of the initial capacitance. These results indicate the excellent mechanical flexibility of the MSC, which is effective for powering next-generation wearable and portable devices.

In order to demonstrate the functionalities of the MSC in harsher environments, the electrochemical performance of the MSC was studied from −15 °C to 70 °C. Initially, the CV test was carried out at a constant sweep rate of 100 mV s⁻¹ at various operating temperatures. The shape of the CV profile maintained a quasi-rectangular profile at various operating temperatures and the response (current values from the CV profile) of the MSC displayed a linear enhancement in the current when the operating temperature was increased from −15 °C to 70 °C, indicating an increase in the specific capacitance with increase in operating temperature. The MSC exhibited a maximum specific capacitance of 343.37 mF cm⁻³ at a 70 °C and a minimum specific capacitance of 240.70 mF cm⁻³ at −15 °C.

To further clarify this behavior, a CD test was performed at the same temperature (from −15 °C to 70 °C) as CV. The CD test was carried out at a constant applied current of 1 μA and demonstrated an increase in charging and discharging time with increase in operated temperature (similar observation as in CV). The variation of volumetric specific capacitance with respect to various operating temperatures provided the maximum specific capacitance of up to 416.15 mF cm⁻³ at 70 °C from 262.21 mF cm⁻³ at −15 °C. The increase in the specific capacitance by 158% at higher temperature (70 °C) compared to the lower temperature (-15 °C) was due to the enhanced diffusivity and mobility of the electrolyte ions at a higher temperature.

### Example 4—Production of MSC from Oxygenated Graphene Inks in Series and Parallel Configurations

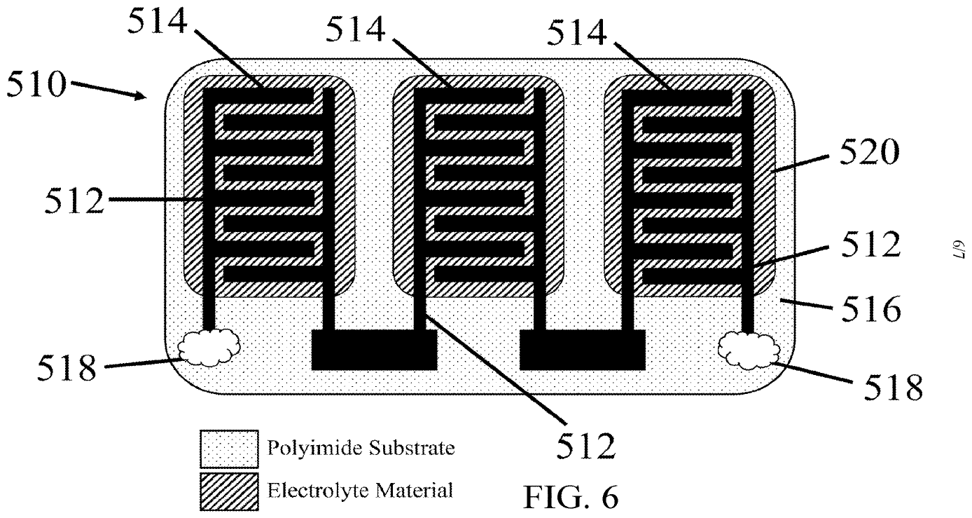

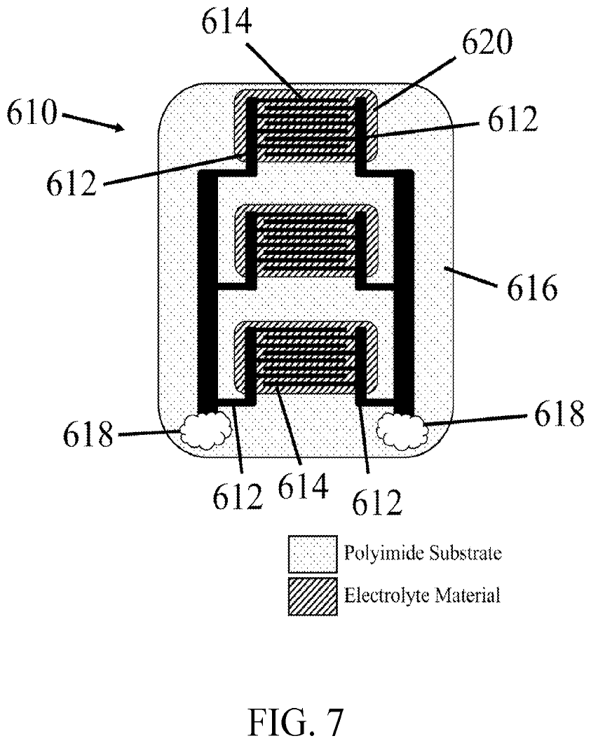

As shown in FIGS. 6 and 7, MSCs according to the configurations of Example 3 were produced in series and parallel configurations, respectively, in order to demonstrate the tunable operating voltage and current output. More particularly, as shown in FIG. 6, an MSC 510 with a series configuration was produced with a number of printed electrodes 512 containing a plurality of fingers 514 printed on a polyimide substrate 516. As shown in FIG. 6, the electrodes 512 were printed in a series configuration starting and ending in the contact points 518. An electrolyte material 520 was applied on top of the interacting electrodes 512. Alternatively, FIG. 7 depicts an MSC 610 having a parallel configuration with a number of electrodes 612 containing a plurality of fingers 614 printed on a polyimide substrate 616. The MSC 610 had two contact points 618 and an electrolyte material 620 covering the interacting electrodes 612.

The CV profiles of the MSC in series connection (three devices) revealed an approximately rectangular shape. The increase in working voltage from 1.0 V to 3.0 V with rectangular shape indicated the characteristic of EDLC. Similarly, the CD profile of the series MSC was tested at an applied current of 1 μA. The nature of CD profiles represented the proportional increase in the device voltage from 1.0 V to 3.0 V when series connected from single device to three devices, respectively. To confirm the electrochemical performance of the series connected devices (three devices), CV and CD test were performed at various sweep rates (25-250 mV s−1) and applied currents (3-0.2 μA).

Further, the electrochemical performance of the parallel configuration was carried out using CV and CD tests. The CV profile indicated a rectangular shape with a proportionally increased area and/or current by combining the number of parallel MSCs from 1 to 3. Correspondingly, the discharge time of three parallel connected MSCs increased at the same applied current compared to a single MSC.

### DEFINITIONS

It should be understood that the following is not intended to be an exclusive list of defined terms. Other definitions may be provided in the foregoing description, such as, for example, when accompanying the use of a defined term in context.

As used herein, the terms “a,” “an,” and “the” mean one or more.

As used herein, the term “about” refers to a range within +10% of the stated value. For example, “about 10” would cover a range of 9 to 11.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination, B and C in combination; or A, B, and C in combination.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “having,” “has,” and “have” have the same open-ended meaning as “comprising,” “comprises,” and “comprise” provided above.

As used herein, the terms “including,” “include,” and “included” have the same open-ended meaning as “comprising,” “comprises,” and “comprise” provided above.

### NUMERICAL RANGES

The present description uses numerical ranges to quantify certain parameters relating to the invention. It should be understood that when numerical ranges are provided, such ranges are to be construed as providing literal support for claim limitations that only recite the lower value of the range as well as claim limitations that only recite the upper value of the range. For example, a disclosed numerical range of 10 to 100 provides literal support for a claim reciting “greater than 10” (with no upper bounds) and a claim reciting “less than 100” (with no lower bounds).

### CLAIMS NOT LIMITED TO DISCLOSED EMBODIMENTS

The preferred forms of the invention described above are to be used as illustration only, and should not be used in a limiting sense to interpret the scope of the present invention. Modifications to the exemplary embodiments, set forth above, could be readily made by those skilled in the art without departing from the spirit of the present invention.

The inventors hereby state their intent to rely on the Doctrine of Equivalents to determine and assess the reasonably fair scope of the present invention as it pertains to any apparatus not materially departing from but outside the literal scope of the invention as set forth in the following claims.

1. An oxygenated graphene ink comprising a plurality of graphene particles, wherein the graphene particles have an oxygen to carbon (“O/C”) ratio of at least 0.3.

2. The oxygenated graphene ink according to claim 1, wherein the O/C ratio is 0.3 to 0.9.

3. The oxygenated graphene ink according to claim 2, wherein the particles comprise at least 50 weight percent of elemental carbon and 10 to 40 weight percent of elemental oxygen.

4. The oxygenated graphene ink according to claim 1, wherein the oxygenated graphene ink comprises 10 to 60 weight percent of the graphene particles.

5. (canceled)

6. (canceled)

7. A method of forming the oxygenated graphene ink according to claim 1, wherein the method comprises:
(a) providing an initial detonation graphene powder having a O/C ratio of at least 0.3;
(b) combining the initial detonation graphene powder with a first solvent and a binder under agitation to thereby form a graphene dispersion;
(c) flocculating the graphene dispersion to thereby form a composite powder; and
(d) forming the oxygenated graphene ink with the composite powder.

8. The method according to claim 7, wherein the providing of step (a) comprises detonating an initial hydrocarbon and oxygen to thereby form the initial detonation graphene powder.

9. The method according to claim 8, wherein the initial hydrocarbon is acetylene, and wherein the binder comprises ethyl cellulose.

10. (canceled)

11. The method according to claim 7, wherein the agitation comprises sonication.

12. The method according to claim 7, wherein the forming of step (d) comprises contacting the composite powder with at least one second solvent under agitation.

13. (canceled)

14. The method according to claim 12, wherein the at least one second solvent comprises a solvent mixture.

15. The method according to claim 14, wherein the solvent mixture comprises cyclohexane and terpinol.

16. (canceled)

17. A device comprising the oxygenated graphene ink according to claim 1.

18. The device according to claim 17, wherein the device comprises a printed surface, a biosensor, a supercapacitor, an electrode, a composite for a battery or a supercapacitor, or an antibacterial and antiviral surface formed with the oxygenated graphene ink.

19. An electronic device comprising a component formed from an oxygenated graphene ink, wherein the oxygenated graphene ink comprises a plurality of graphene particles, wherein the graphene particles have an oxygen to carbon (“O/C”) ratio of at least 0.3.

20. The electronic device according to claim 19, wherein the O/C ratio is from 0.3 to 0.9.

21. The electronic device according to claim 19, wherein the graphene particles comprise at least 50 weight percent of elemental carbon and 10 to 40 weight percent of elemental oxygen.

22. The electronic device according to claim 19, wherein the electronic device is a supercapacitor, wherein the component is an electrode.

23. A process for forming the electronic device according to claim 19, wherein the process comprises printing the oxygenated graphene ink onto a substrate to thereby form a printed structure.

24. The process according to claim 23, wherein the printing comprises inkjet printing.

25. The process according to claim 23, wherein the printed structure has an average thickness in the range of 0.5 to 10 μm.

26. The process according to claim 23, wherein the printed structure is an electrode.
